(19) United States
(12) Patent Application Publication
(10) Pub. No.: US 2021/0034338 A1
(43) Pub. Date: Feb. 4, 2021

(54) Communications Enablement Platform, System, and Method

(71) Applicant: Star2Star Communications, LLC, Sarasota, FL (US)

(72) Inventors: Sergey Galchenko, Aurora, OH (US); Norman A. Worthington, III, Sarasota, FL (US)

(21) Appl. No.: 16/527,610

(22) Filed: Jul. 31, 2019

(51) Int. Cl. G06F 8/38; G06Q 10/06; G06Q 10/10

(52) U.S. Cl. CPC G06F 8/38; G06Q 10/103; G06Q 10/06316

(57) ABSTRACT

The present invention comprises devices, systems, and methods of a novel communications enablement platform (CEP), comprising a communication services module including a first series of communication nodes further comprising microservices, application programming interfaces, metadata discoverers, databases, and gateways. The CEP furthering comprises an integration module, including a second series of communication nodes further comprising application components, patterns, and gateways. The communication services module and the integration module can be operatively coupled via the gateways. The CEP also includes an operatively coupled user interface, where a design user composes integration flows by manipulating the patterns through combination with the microservices, the application programming interfaces, and the application components. The CEP also comprises a controller having an operating system, a coupler, a multimodal input/output for receiving inputs and providing outputs, and a receiver/transmitter to receive and transmit feedback on the integration flows in response to an occurrence of an event.

### FIELD OF THE INVENTION

The present devices, systems, and methods generally relate to communications-enabled business processes, particularly to build interactive communication applications and automate business workflows.

### BACKGROUND OF THE INVENTION

Business communication is a method of information sharing between persons and entities within and outside of an organization that is performed for the commercial benefit of the organization, and encompasses a plurality of topics, such as, for example, marketing, brand management, customer relations, consumer behavior, reputation management, employee engagement, and the like. Likewise, there are a plurality of methods of delivering and receiving business communication, including, but not limited to, web-based, video conferencing, reports, presentations, telephone, face-to-face, and the like, delivered and received over various media channels, such as the Internet, print media, radio, television, ambient media, text messaging, word of mouth and the like. To deliver and receive business communications, many organizations historically were required to purchase standardized individual and separate packaged services and applications, including, but not limited to, a Private Branch Exchange System (PBX) to route incoming calls, contact) text messaging, presence management, and the like.

Unified Communications (UC) and Unified Communications as a Service (UCaaS) have been developed to offer organizations a combination of modalities (i.e., voice, video conferencing, chat, short message service (SMS), etc.) as a single unified user experience. However, as technologies evolve the more traditional “telecom” offerings have transitioned to more software-centric Internet Protocol (IP) and cloud-based offerings of such services, which an end user may access but is not required to maintain at the organization site. With these advances, many organizations require ways to use these existing UC and UCaaS products to drive automation of internal workflows and create interactive end user (i.e., customer) experiences to improve productivity internally and engagement externally.

Therefore, a reliable device, system, or method is needed to be able to provide to an organization a way to integrate existing or “legacy” applications, such as an organization's existing UC and UCaaS applications. This reliable device, system, and method would need to be simultaneously accessible to a knowledgeable but not expert user (described below as a “design user”) but also be robust in the provision of applications and services.

### SUMMARY OF THE INVENTION

It is, therefore, an object of the present invention to provide a novel communications enablement platform (CEP), a system further including the novel CEP, and methods for the use of such platform and system.

The present invention may optionally operate within a number of communications and network environments, for example, but in no way limited to, the public Internet, a private Internet or Intranet, a network on one side of a third-party provided address family translation or network address translation (NAT) implementation, a network on a second side of a third-party provided NAT implementation, a data transport network or a series of networks, a communications network or series of networks, a non-optimized communications network or series of networks, an optimized communications network or series of networks, and the like.

In one exemplary embodiment, a CEP is provided. The CEP can further comprise a communication services module, an integration module, a user interface, and a controller.

In one aspect of the exemplary embodiment, the communication services module can comprise a first series of communication nodes, which can further comprise any one or a combination of the following elements: a microservice, an application programming interface, a metadata discoverer, a database, and a one or a “first” gateway.

In another aspect of the exemplary embodiment, the integration module can comprise a second series of communication nodes, which can further comprise any one or a combination of the following elements: an application component, a pattern, and a one or a “second” gateway. The communication services module and the integration module can be operatively coupled via the first gateway and the second gateway.

In a further aspect of the exemplary embodiment, the user interface can be operatively coupled to the communication services module and the integration module via the first gateway and the second gateway. A design user can compose an integration flow at the user interface by manipulating a pattern through combining it with any one or a combination of the following elements: a microservice, an application programming interface, and an application component.

In yet still another aspect of the exemplary embodiment, the controller can further comprise an operating system, a coupler, a multimodal input/out, and a receiver/transmitter.

The operating system can, via a network connection, direct and control the operation and function of the CEP. The coupler can, via a network connection, operatively couple the first gateway, the second gateway, the communication services module, the integration module, and the user interface. The multimodal input/output can, via a network connection, receive a multimodal input and provide a multimodal output based on a design user requirement received through the user interface. The receiver/transmitter can, via a network connection, receive and transmit a feedback of the integration flow to the design user in response to an occurrence of an event.

The following are either or both additional and exemplary aspects of the present exemplary embodiment, one or more of which can be combined with the basic inventive CEP embodied above:

the communication services module can further comprise the microservice and the database being exposed via the first gateway;

the integration module can further comprise the coupler operatively coupling the integration module via the first gateway, whereby via the coupler the integration module accesses the microservice and the database;

the user interface can further comprise providing access to the application component and the pattern to the design user;

the user interface further comprising providing access to the at least one microservice and the database to the design user;

user interface further comprises allowing the design user to compose the at least one integration flow via a combination of one or more of the following: the at least one application component, the at least one microservice, and the at least one pattern;

operatively coupling via the coupler further comprises a multidirectional data exchange between the communication services module, the integration module, and the user interface;

providing the multimodal output further comprises receiving and analyzing an at least one activity detail collected via the metadata discoverer and stored in the database;

the controller receives one or more multimodal inputs and provides one or more multimodal outputs based on the at least one design user requirement received via the user interface;

the controller receives and transmits one or more feedbacks to the design user based on the use of the at least one integration flow in response to the occurrence of the event;

the controller receives and transmits the one or more feedbacks to the design user based on the use of the at least one integration flow in response to the occurrence of one or more of the events.

In another exemplary embodiment, a system including the CEP is provided. The system further comprises a first user device, a second user device, the CEP, and a network. The network, as a component of this exemplary embodiment, connects the first user device, the second user device, and the CEP. The CEP, as embodied as a component of this exemplary embodiment, demonstrates the “communications enablement,” as stated above.

In another exemplary embodiment, methods for composing an integration flow using the CEP individually and as part of the exemplary system are provided. Such exemplary methods combine the basic inventive concept(s) as embodied in the above exemplary CEP and exemplary system.

In one exemplary aspect of the composing method a design user using an at least one first user device can access a user interface operatively coupled to a communication services module and an integration module of a CEP via a network.

In another exemplary aspect, the communication services module can further comprise a first series of communication nodes further comprising at least one of each of the following: a microservice, an application programming interface, a metadata discoverer, a database, and a first gateway.

In a further exemplary aspect, the integration module can further comprise a second series of communication nodes further comprising at least one of each of the following: an application component, a pattern, and a second gateway, wherein the communication services module and the integration module are operatively coupled via the at least one first gateway and the at least one second gateway.

In yet another exemplary aspect, the user interface can be operatively coupled to the communication services module and the integration module via the at least one first gateway and the at least one second gateway.

In another exemplary aspect of the composing method, the CEP can further comprise a controller, the controller further comprising an operating system, a coupler, a multimodal input/out, and a receiver/transmitter.

In another exemplary aspect, the operating system can direct and control the operation and function of the CEP.

In another exemplary aspect, the coupler can operatively connect the user interface, the communication services module, and the integration module.

In another exemplary aspect, the multimodal input/output can receive a multimodal input and provide a multimodal output based on an at least one design user requirement created by the design user.

In another exemplary aspect, the receiver/transmitter can receive and transmit a feedback of the integration flow to the design user in response to an occurrence of an event.

In yet another exemplary aspect of the composing method, the design user can compose the integration flow at the user interface by manipulating the at least one pattern through combination with at least one of the following: the at least one microservice, the at least one application programming interface, and the application component.

In yet a further exemplary aspect of the composing method, the design user can activate the integration flow delivering an output to an end user using an at least one second user device.

In yet still a further exemplary aspect of the composing method, the end user can interact with the output to create the occurrence of the event resulting in the feedback of the integration flow transmitted to the design user.

These and other exemplary aspects of the present basic inventive concept are described below. Those skilled in the art will recognize still other aspects of the present invention upon reading the included detailed description.

### DETAILED DESCRIPTION OF THE DRAWINGS

The present invention is illustrated by way of example, and not limitation, in the figures depicted in the following drawings.

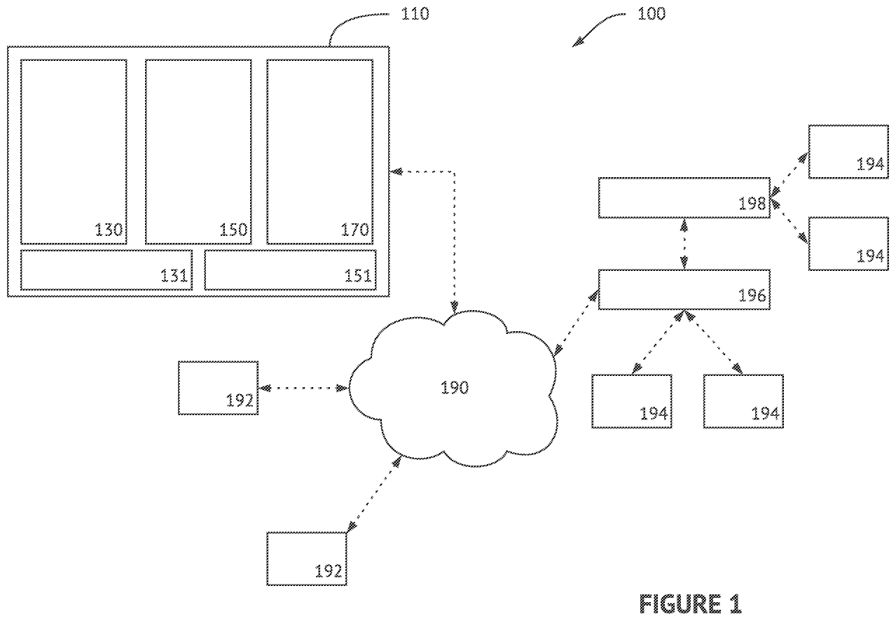

FIG. 1 an exemplary “communications environment” in which an exemplary embodiment of the present invention may operate.

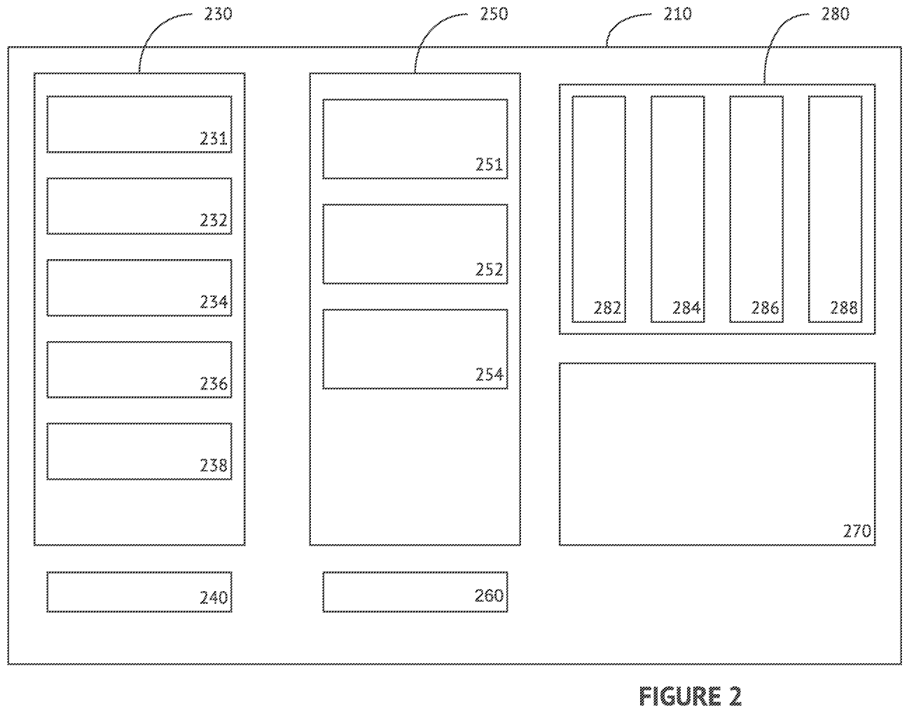

FIG. 2 illustrates an exemplary embodiment of the present invention, an exemplary communications enablement platform (CEP).

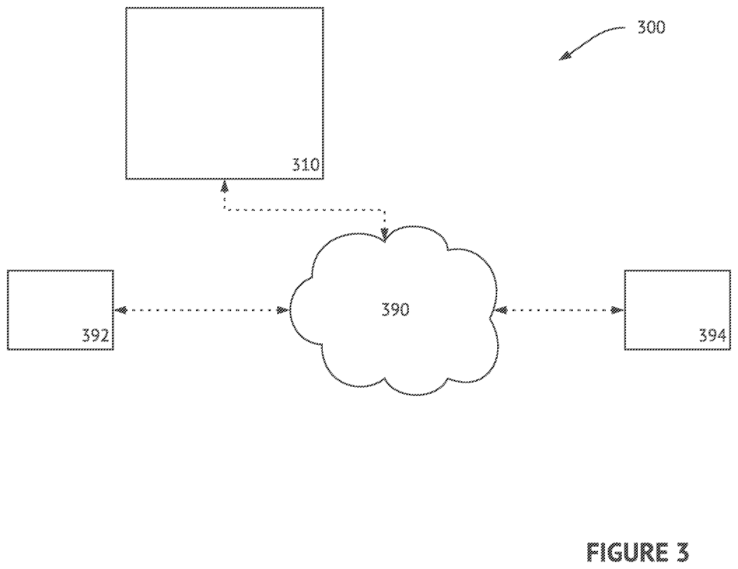

FIG. 3 illustrates another exemplary embodiment of the present invention, a system, in at least one element of the communications environment illustrated in FIG. 1 is present and within which a CEP may operate.

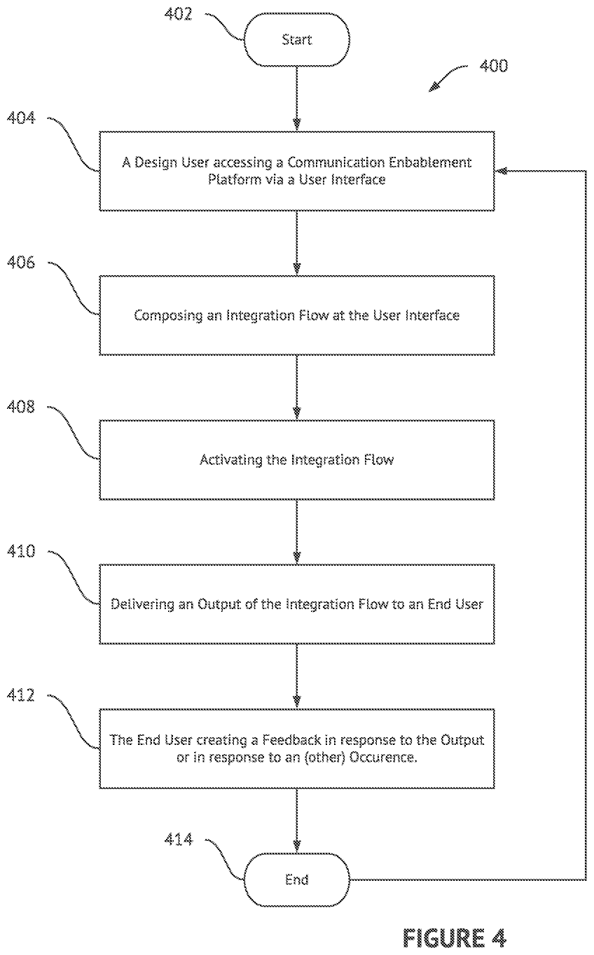

FIG. 4 illustrates one exemplary aspect of the present invention, an exemplary method for composing an integration flow using an exemplary CEP.

### DETAILED DESCRIPTION OF THE INVENTION

The present invention will now be described more fully herein with reference to the accompanying drawings, which form a part of, and which show, by way of illustration, specific exemplary embodiments through which the invention may be practiced. This invention may, however, be embodied in many different forms and should not be construed as limited to the exemplary embodiments set forth below. Rather, these exemplary embodiments are provided so that this disclosure will be thorough and complete, and will fully convey the scope of the invention to those skilled in the art. Among other things, the present invention may be embodied as devices, systems, and methods. Accordingly, various exemplary embodiments may take the form of entirely hardware embodiments, entirely software embodiments, and embodiments combining software and hardware aspects. The following detailed description is, therefore, not to be taken in a limiting sense.

Throughout this specification and claims, the following terms take the meanings explicitly associated herein, unless the context dictates otherwise. The phrases “in one embodiment” and “this exemplary embodiment” do not necessarily refer to the same embodiment, though they may. Furthermore, the phrases “in another embodiment,” “additional embodiments,” and “further embodiments” do not necessarily refer each or collectively to a different embodiment, although they may. As described below, various embodiments of the invention may be readily combined, without departing from the scope or spirit of the invention.

Also, the term “or” is an inclusive “or” operator and is equivalent to the term “and/or,” unless the context dictates otherwise. The term “based on” is not exclusive and allows for being based on additional factors not described, unless the context dictates otherwise. In addition, throughout the specification, the meaning of “a,” “an,” and “the” include plural references. The meaning of “in” includes “in” and “on.”

The following briefly describes one of the exemplary embodiments of the present invention, to provide a basic understanding of some aspects of the invention. This brief description is not intended as an extensive overview, nor is it intended to identify key or critical elements, to delineate, or otherwise, narrow the scope. Its purpose is to present concepts in a simplified form as a prelude to a more detailed description which is presented later. The present invention, generally, is directed towards a hardware computing solution which comprises three or more tightly coupled, distinct computing infrastructure components associated with a library of pre-built, pre-tested, and reusable coding “building blocks” which a design user can operably combine using a plurality of combination or programming methods to create an interactive end user application, in one example, to automate a business workflow, otherwise described herein as an “integration flow.”

Below, exemplary embodiments will be provided in conjunction with the attached drawings. The written description below will begin with reference to FIG. 1 and will include a high-level, generalized description of a “communication system” in which the present invention can be practiced. FIGS. 2 through 4 thereafter will discuss various aspects and embodiments of the present invention, in more detail.

FIG. 1 illustrates an embodiment of a communication system 100, which is an exemplary environment in which the present inventive concept and its individual elements can be practiced, constructed and operated, in whole, in part, and any order or combination. Communication system 100 includes at least one communication server 110, communication nodes 131, 151, and exemplary networks 190. Communication system 100, generally, involves the connection of the various elements and components described herein for the transmission of communication sessions via electronic transfer of data over one or more third-party networks (i.e., networks 190), which generally includes transfer through a series of communication nodes (i.e, communication nodes 131, 151). A communication session generally comprises data packets (either or both signaling and data packets) passed using a communication protocol and generally relating to one or more of the following non-exhaustive application types: audio only; audio and video; audio and data; or any combination of audio, video, and data over a digital medium. One knowledgeable in the art should understand that the phrase “communication session” is generally synonymous with the term “connection.” As such, it should be realized that one exemplary embodiment of communication system 100, can include, but is not limited to, an Internet protocol (IP)-based communication system architecture that provides one or more end users with an end-to-end, fully managed and monitored system for transporting audio, video, and other data traffic over third party networks.

As illustrated, communication system 100 comprises a plurality of components in addition to communication server no, communication nodes 131, 151, networks 190, for example, one or more endpoints 192 (each individually an endpoint 192 or collectively endpoints 192) for either or both initiating and receiving communication sessions (i.e., both incoming and outgoing). Within this exemplary embodiment, communication sessions may be between the illustrated endpoints 192, between endpoints 192 and one or more endpoints 194 (each individually an endpoint 194 or collectively endpoints 194), as well as between endpoints 192, 194 and other endpoints not shown. It should be understood that a communication session between endpoints 192, 194, and endpoints not shown can be, for example, in a two-party manner, or can involve other endpoints (also not shown) in a multi-party manner, such as, in a multi-endpoint (i.e., multi-user) communication session. In this exemplary embodiment, as shown in FIG. 1, communication sessions sent or received from endpoints 192 can be managed and operated by an optimized communication server (not shown), whether or not endpoints 192, 194 are geographically distributed. Also, it will be understood that in alternate embodiments the endpoints 192, 194 are not limited by connection to a traditional switched telephone network or “PSTN,” such as PSTN 196, as shown in

FIG. 1. For example, in such embodiments, endpoints 192 can be connected directly (i.e., without PSTN 196) to a network, such as networks 190.

Communication sessions involving endpoints 192, 194 occur via one or more networks 190 and are typically associated with one or more of the following, by way of example and not limitation, a web-deployed service with client/service architecture, a cellular data network, a cloud-based system, secure data networks, and gateways/firewalls that provide information security, and the like. Moreover, as will be understood and appreciated, various networking components such as routers, switches, hubs, and the like, are generally also involved in transmitting communication sessions, but not illustrated for simplicity purposes.

Endpoints 192, 194 generally are defined as electrical or electronic equipment that can be connected to an IT infrastructure, and that can enable electronic communications (e.g., communication sessions). For example and in no way in limitation, endpoints 192, 194 may comprise any singular or combination of a VoIP phone, a mobile phone, a fax machine, a conventional Plain Old Telephony System (POTS) phone, a smart phone, a cordless phone, a conference room speakerphone, a computer, a Bluetooth-enabled phone, a laptop, audio/video conferencing equipment, electronic gaming equipment, a tablet, a printer, or more generally, any kind of processing device which can connect to a network and to or from which an end user can operatively practice a communication function. Further, in locations, in one example, physical organizations, analog or digital overhead paging systems may be utilized. Such legacy systems (including existing communications circuits that transmit data at speeds around 1.544 megabits per second, also known as “T1” circuits or POTS trunks) can be integrated with optimizing server elements via adapters (not shown). As will be understood and appreciated, there is no limitation imposed on the number of endpoints, endpoint types, brands, vendors, and manufacturers, etc. that may be used in connection with embodiments of the present invention.

In a general or traditional communications network, an outgoing (which can also be known as “placed,” “sent,” and in purely voice sessions, “terminating”) communication session will travel from endpoint 192 via one or more networks 190, through the IP-PSTN gateways 198 where IP traffic is converted into telephony or data traffic and is finally delivered to endpoint 192 or another endpoint (not shown). The reverse happens for an incoming communication session (which can also be known as “received,” “delivered,” and in purely voice sessions “originating”). As will be discussed in reference to this FIG. 1, additional configurations of communication traffic will be illustrated, for example, generated via endpoints (not shown), and passed from communication nodes 131, 151 via networks 190 and thereafter routed through communication server 110. In one example, incoming traffic may be directed to communication server 110 and thereafter communication nodes 131, 151 for eventual delivery to specific endpoints 192, 194, via, for example, communication node 131, 151, and the like. In an alternative example, incoming traffic may be redirected to an automated attendant, call queues, voicemail, or an off-premises device (e.g., an end user's mobile phone or home phone).

According to one embodiment, and as shown in FIG. 1, communication server 110 may integrally comprise one or more of communication nodes 131, 151, and computing elements 130, 150, 170, while being connected with networks 190. Through these connections, as shown, communication server no can be operatively connected to one or more of the endpoints 192,194, and in additional exemplary embodiments, one or more remotely-located communication server modules (not shown). In one embodiment, communication server 110 monitors and collects real-time and historical network characteristics, applies organization level methodologies for specific business requirements, embodied as executable instructions stored in a form of computer-readable media related to networks 190 characteristics, evaluates various communication session routes/paths, and if necessary modifies communication routes to account for the application of entity-specific requirements and real-time networks characteristics. For purposes of the claims and this specification, communication server no is further contemplated to comprise such hardware or software computing elements 130, 150, 170 and components as necessary to embody the communications enablement platform (CEP) 210, as illustrated in more detail with reference to FIG. 2, below.

Communication server 110, as shown in FIG. 1, is intended to be any singular or collection of computing elements 130, 150, 170 or communication nodes 131, 151 that provide a suite of hosted services to create a complete, feature-rich communication system. As such, communication server no may comprise any combination of computing components, by way of example, but in no way required or limited to, processing units (CPUs), mass memory, buses, RAM, ROM, and other storage means (all of which are not shown for simplicity purposes). In this exemplary embodiment, mass memory may include an example of computer-readable storage media for storing information such as computer-readable instructions, data structures, databases (such as, for example database 238 illustrated in FIG. 2), program modules or other data, basic input/output system (“BIOS”) for controlling low-level operations of communication server 110, as well as an operating system for controlling the operation of communication server 110. It should be appreciated that these components may include a general-purpose operating system such as a version of UNIX® or LINUX™, or any other operably functional operating system that comprises software to support communication server's no basic functions. The operating system may include, or interface with, Java virtual machine modules that enable control of either or both hardware components and operating systems operations, via Java application programs.

Additional exemplary embodiments of communication server no can optionally include any singular or collection of computer servers or communication nodes for storing data associated with providing communication sessions, i.e., databases (such as, for example, database 238 depicted in FIG. 2) further comprising directories of information identifying characteristics relating to various communication nodes, also including, but not limited to, a catalog of supported or available codecs. Non-limiting examples of such directory information can include, for example, IP addresses of the respective communication nodes, a network type (i.e., which of a variety of available networks a communication is in or associated with), a codec or a set of codecs compatible with a communication node, or network, and a type of application data (i.e., audio, video, data, or any combination thereof) the respective communication node processes. Databases, in these exemplary embodiments may, in one example, be relational, which can be defined as tabular databases with data defined so that it may be reorganized and accessed in a number of ways, and in another example distributed, which can be defined as dispersed or replicated databases located among different points in the networks.

Further embodiments of communication server 110 can optionally include any singular or collection of computer servers or communication nodes for storing data associated with the communication sessions, i.e., databases (such as, for example, database 238 depicted in FIG. 2) further comprising directories of information identifying characteristics relating to communication session activity detail, by way of example and no way in limitation, data on the origin of a communication session, its destination, route, time, date, size, duration, type of underlying service, modal or end user interactive response, or the like.

In FIG. 1, as shown, communication nodes 131, 151 are operatively connected to the communication server 110, via one or more networks, such as, for example, networks 190 including, but not limited to, the Internet, another public network, or a private network. In general, communication nodes 131, 151 can be any type of IP-enabled device that connects to a network (such as networks 190) and enables communication sessions. Non-limiting examples of communication nodes 131, 151 include network edge devices, PBX servers, provisioning servers, route servers, media proxy servers, statistics servers, gateways (such as, in one example, first gateway 240 and second gateway 260, as illustrated in reference to FIG. 2), network-attached component devices, border controllers, and the like.

It will be further understood that the terms “network,” “networks,” “at least one network,” or “networks 190” or each individually referenced as a network (i.e., “network 190”) as used herein generally include any kind of computer-enabled, IP-enabled, or other digital network for transporting data or traffic associated with communication sessions, and generally include a network in a system of interconnected computing devices, servers, nodes, or endpoints. As illustrated, networks 190, each represents a connected yet different network in a series. In one example, a network includes the Internet that is a global system of interconnected computers that use the standard IP suite to serve end users worldwide with an extensive range of information resources and services. It should also be understood that the term “Internet” as used herein and generally, in reality, is a network of networks consisting of millions of private, public, academic, business, and government networks, of local to global scope, that is linked by a broad array of electronic, wireless and optical technologies. As described in reference to this specification and the claims, communication nodes generally connect to networks, and networks may comprise one or more communication nodes and network edge devices as illustrated in these exemplary embodiments, for example, communication nodes 131, 151, networks 190.

Usually, such networks are offered as commoditized services by third-party Internet service providers (ISPs) and include a plurality of one or more third-party sub-networks that are usually owned by third party network providers or third-party carriers. Such sub-networks can be hard-wired or wireless, including, but not limited to, cellular, optical fiber, Wi-Fi, WiMax®, proprietary networks, and the like, as should occur to one skilled in the art. It should also be understood by one skilled in the art that networks 190 can further include PSTN nodes such as IP-PSTN gateway (such as, for example, PSTN 196) at the boundary of IP networks, and PSTN 196 can also function as a conversion between PSTN traffic and IP traffic.

FIG. 2 illustrates one exemplary embodiment of a communication enablement platform (CEP) 210. CEP 210, as shown, contains a number of computing or hardware processing elements, including, but not limited to, a communication services module 230, an integration module 250, a user interface 270, and a controller 280. CEP 210 can generally be considered to be any type of IP-enabled device that connects to a network and enables communication sessions. As referred to herein, examples may include but are not limited to network servers, communication nodes, network edge devices, provisioning servers, route servers, media proxy servers, statistics servers, and the like. Additional examples may further include PSTN nodes (i.e., nodes that are maintained by third-party communication providers), PBX nodes (i.e., nodes that are connected to a PBX), central processing units, such as, the electronic circuitry within a computing device that carries out the instructions of a computer program by performing the basic arithmetic, logical, control and input/output (I/O) operations specified by the instructions. The instructions to be executed are generally kept in some kind of memory, and the like.

CEP 210, as embodied herein, can optionally have all the same or similar components as described above with reference to communication server no in FIG. 1. CEP 210 may additionally comprise any combination of computing components, by way of example, but in no way required or limited to, central processing units (CPUs), mass memory, buses, RAM, ROM, and other storage means (all of which are not shown for simplicity purposes). Controller 280, for purposes of this illustration, directs the overall functionality of CEP 210, as well as executes computer-readable instructions stored in memory (not illustrated), which cause CEP 210 to transform a received design user requirement to allow the composition of an integration flow as described herein.

Communication services module 230 may be generally defined as a computing module, i.e., a selection of independent computing devices packaged together to provide the basic functionality of “communication services.” Communication services generally include services for the transmission of voice, data, texts, sound, images, and the like. Examples include, but are not limited to, landline or mobile telephony, advanced services such as toll-free numbers, multi-party lines, fax, satellite or submarine networks, transport of data, short message service (SMS), customized routing of data, interconnection, services, services for access to the Internet, services for the broadcasting of television and radio programs, and other services such as management of private integrated networks, private mobile radio services, rental services, videoconferencing, chat services, and the like.

Communication services module 230 can comprise a first series of communication nodes 231, which can further comprise any one or a combination of the following elements, a microservice 232, an application programming interface 234, a metadata discoverer 236, a database 238, and a one or a “first” gateway 240.

First series of communication nodes 231 can generally be defined as any series of IP-enabled devices that connects to a network and enables the use of communication services to initiate communication sessions. Examples include, but are not limited to, network servers, communication nodes, network edge devices, provisioning servers, route servers, media proxy servers, statistics servers, and the like. Additional examples may further include PSTN nodes (i.e., nodes that are maintained by third-party communication providers), PBX nodes (i.e., nodes that are connected to a PBX), central processing units, and the like.

Microservice 232 customarily is a software development technique, often a variant of service-oriented architecture (SOA), i.e., a computing architectural style that structures an application as a collection of loosely coupled services. In one exemplary microservices architecture, services can be “fine-grained” and the protocols “lightweight.” Decomposing an application into these different, smaller services improves modularity, making an application easier to understand, develop, test, and become more resilient to architecture erosion, by generally parallelizing development, enabling small, autonomous teams to develop, deploy, and scale services independently. Primarily, microservices-based architectures enable continuous delivery and deployment. Examples of the defining characteristics of microservices include but are not limited to, these services often communicate over a network using protocols such as HTTP, use shared memory, services may run the same process in a bundle format, can be independently deployable, the granular organization, implementation using different programming languages, databases, hardware and software environments, and the like. Further examples of microservices comprise being small in size, messaging enabled, bounded by contexts, autonomously developed, independently deployable, decentralized and built and released with automated processes, and the like.

Application programming interface 234 or “API” 234 can generally be described as a set of subroutine definitions, protocols, and tools for building application software. In general terms, API 234 can be a set of clearly defined methods of communication between various software components. Generally, a functionally operable API makes it easier to develop a computer program by providing all the building blocks, which are then put together by a programmer or design user. Exemplary embodiments of API 234 may be for a web-based system, operating system, database system, computer hardware, or a software library. API 234 specification can take many forms, for example, but commonly include specifications for routines, data structures, object classes, variables or remote calls, and the like. Industry-standard application programming interfaces include, but are not limited to, POSIX, Microsoft Windows API, the C++ Standard Template Library and Java APIs.

Metadata discoverer 236 can generally be considered a computing element engaged for metadata discovery, the process of using automated tools to discover the semantics of a data element in data sets. Usually, metadata discovery results in a set of mappings between the data source elements and a centralized metadata registry. Metadata discovery may also be known as metadata scanning. Discovered metadata sets may be in a variety of different forms including, but not limited to, relational databases, spreadsheets, XML files, web services, software source code in various programming languages, unstructured text documents, and the like.

Generally, in computing and data management, data mapping can be the process of creating data element mappings between two distinct data models. As contemplated in the exemplary embodiment illustrated in FIG. 2, data mapping by metadata discoverer 236 (in conjunction with data sets stored in database 238) can be used as a first step for a wide variety of data integration tasks as contemplated by integration module 250. Examples of exemplary data mapping may include but are not limited to data transformation or data mediation between a data source and a destination, identification of data relationships as part of data lineage analysis, discovery of hidden sensitive data hidden in another user id as part of a data masking, consolidation of multiple databases into a single database and identifying redundant columns of data for consolidation or elimination, and the like.

An additional function contemplated for metadata discoverer 236 in additional embodiments includes data mining. Data mining can generally be defined as a process of discovering patterns in large data sets involving methods at the intersection of machine learning, statistics, and database systems. Data mining is generally an interdisciplinary subfield of computer science and statistics with an overall goal to extract information (with intelligent methods) from a data set and transform the information into a comprehensible structure for further use by computing devices, such as, for example, integration module 250, as well as humans. Data mining is the analysis step of the “knowledge discovery in databases” process. Aside from a raw analysis step, data mining may optionally involve database and data management aspects, data pre-processing, model and inference considerations, interestingness metrics, complexity considerations, post-processing of discovered structures, visualization, online updating, and the like. A main difference between data analysis and data mining is that data analysis can be used to summarize history, in contrast, data mining focuses on using specific machine learning and statistical models to predict the future and discover the patterns among data.

As further illustrated in FIG. 2, database 238 can be generally be defined as an organized collection of data, generally stored and accessed electronically from a computer system. One way to classify databases, such as database 238, involves the type of their contents, for example, bibliographic, document-text, statistical, or multimedia objects. Another way is by their application area, for example, accounting, music compositions, movies, banking, manufacturing, or insurance. A third way is by some technical aspect, such as the database structure or interface type. Examples of databases may include but are not limited to in-memory, active, cloud, a data warehouse, deductive, document, embedded, federated, graph, array, hypertext or hypermedia, knowledge base, mobile, operational, parallel, shared memory architecture, shared-disk architecture, shared-nothing architecture, probabilistic, real-time, spatial, temporal, terminology-oriented, unstructured, and the like.

First gateway 240 can optionally refer to a piece of networking hardware which can be a network node equipped for interfacing with another network that uses different protocols. Generally, a gateway, such as first gateway 240, may contain devices such as protocol translators, impedance matching devices, rate converters, fault isolators, signal translators as necessary to provide system interoperability or the like. Gateways, such as first gateway 240, may also require the establishment of mutually acceptable administrative procedures between one or more networks (for example, networks 190, 390, respectively, as illustrated in FIGS. 1 and 3).

In one exemplary embodiment of first gateway 240, first gateway 240 may comprise a protocol translation/mapping gateway, which interconnects networks with different network protocol technologies by performing the required protocol conversions. Additional embodiments further contemplate first gateway 240 being a computer or computer program configured to perform the tasks of a gateway. First gateway 240 may optionally also be a protocol converter and can operate at any network layer. Generally, the activities of a gateway are more complex than that of the router or switch as it communicates using more than one protocol.

Additional embodiments further contemplate first gateway 240 being a cloud storage gateway or a network appliance or server which resides at an end user premises and translates cloud storage application programming interfaces (APIs), such as, for example, “SOAP” or “REST” to block-based storage protocols such as “iSCSI,” or file-based interfaces such as “NFS” or “CIFS.” Commonly, cloud storage gateways enable integration to private cloud storage into applications without moving the applications into a public cloud, thereby simplifying data protection. Still additional embodiments of first gateway 240 further include first gateway 240 being an Internet-to-orbit gateway (I2O), generally described as a machine that acts as a connector between computers or devices connected to the Internet and computer systems orbiting Earth, such as satellites or manned spacecraft. Such a connection is made when the 120 establishes a stable link between a spacecraft and a computer (or a network of computers) on the Internet; such links can be for control signals, audio frequency, or visible spectrum signals.

Additional embodiments of communication services module 230 optionally may further comprise microservice 232 and database 238 being exposed via first gateway 240. When a computing element “exposes” certain functions, it makes those routines available to a design user, through a programming interface or the like, in one example API 234 or first gateway 240.

As further depicted in FIG. 2, integration module 250 can generally be considered an individual or a grouping of computing devices which function via a network to functionally integrate systems. System integration can generally be defined in engineering as the process of bringing together the component sub-systems into one system (i.e., an aggregation of subsystems cooperating so that the system can deliver the overarching functionality) and ensuring that the subsystems function together as a system, and in information technology as the process of linking together different computing systems and software applications physically or functionally, to act as a coordinated whole. As contemplated in the exemplary embodiment of integration module 250 as illustrated in FIG. 2, integration module 250 integrates discrete systems utilizing a variety of techniques such as computer networking, enterprise application integration, business process management, manual programming, and the like.

System integration via integration module 250 can optionally involve integrating existing, often disparate systems, and may also comprise adding value to the system, such as, for example, capabilities that are possible because of interactions between subsystems. Systems integration may occur through a variety of processes or methodologies, in one example, vertical integration (as opposed to “horizontal integration” described below), generally the process of integrating subsystems according to their functionality by creating functional entities also referred to as silos. The benefit of this method is that the integration is performed quickly and involves only the necessary vendors; therefore, this method is cheaper in the short term. On the other hand, cost-of-ownership can be substantially higher than seen in other methods, since in case of new or enhanced functionality, the only possible way to implement (scale the system) would be by implementing another silo. Reusing subsystems to create another functionality is not possible.

Horizontal integration or Enterprise Service Bus (ESB), in contrast, is an integration method in which a specialized subsystem is dedicated to communication between other subsystems. This allows cutting the number of connections (interfaces) to only one per subsystem which will connect directly to the ESB. The ESB is capable of translating the interface into another interface. This allows cutting the costs of integration and provides extreme flexibility. With systems integrated using this method, it is possible to completely replace one subsystem with another subsystem which provides similar functionality but exports different interfaces, all this completely transparent for the rest of the subsystems. The only action required is to implement the new interface between the ESB and the new subsystem.

Alternatively, systems integration may occur via star integration, also known as spaghetti integration, a process of systems integration where each system is interconnected to each of the remaining subsystems. When observed from the perspective of the subsystem which is being integrated, the connections are reminiscent of a star, but when the overall diagram of the system is presented, the connections look like spaghetti, hence the name of this method. Cost of this form of integration may vary due in part to the interfaces that variable subsystems require to export. In a case where the subsystems are exporting heterogeneous or proprietary interfaces, the integration cost can substantially rise. Time and costs needed to integrate the systems increase exponentially when adding additional subsystems. From the feature perspective, this method often seems preferable due to the extreme flexibility of the reuse of functionality.

Integration module 250 may further comprise a second series of communication nodes 251, which can further comprise any one or a combination of the following elements, an application component 252, a pattern 254, and a one or a “second” gateway 260. As contemplated in the exemplary embodiment as illustrated in FIG. 2, communication services module 230 and integration module 250 can be operatively coupled via first gateway 240 and second gateway 260. Coupling is usually contrasted with cohesion. Low coupling often correlates with high cohesion and vice versa. Low coupling is often a sign of a well-structured computer system and a good design, and when combined with high cohesion, supports the general goals of high readability and maintainability. Coupling can be “low” (also “loose” and “weak”) or “high” (also “tight” and “strong”).

Second series of communication nodes 251 and second gateway 260 can be defined as substantially similar to first series of communication nodes 231 and first gateway 240, therefore, for simplification purposes, no further description will be provided for these elements as illustrated.

Application component 252 can generally be defined as a computer program designed to perform a group of coordinated functions, tasks, or activities for the benefit of the end user. Examples of application component 252 can include a word processor, a spreadsheet, an account application, a web browser, a media player, a console game, a photo editor, and the like. The collective noun “application software” refers to all applications collectively. This contrasts with system software, which is mainly involved in running computing hardware. In additional embodiments contemplated for application component 252, application component 252 may be bundled with a computer and its system software or published separately and may be coded as proprietary, open source, or a combination.

Pattern 254 can further be described as a general, reusable solution to a commonly occurring problem within a given context in software design. Pattern 254, as contemplated in this exemplary embodiment, is not a finished design that can be transformed directly into source or machine code. Instead, it is a description or template for how to solve a problem that can be used in many different situations. Generally, “design patterns” are formalized best practices that a programmer, i.e., “design user” can use to solve common problems when designing an application or system.

One example of pattern 254 includes but is not limited to object-oriented design patterns, which typically show relationships and interactions between classes or objects, without specifying the final application classes or objects that are involved. These types of patterns imply a mutable state and may be unsuited for functional programming languages, some patterns can be rendered unnecessary in languages that have built-in support for solving the problem they are trying to solve, and object-oriented patterns are not necessarily suitable for non-object-oriented languages.

An additional example of pattern 254 includes design patterns, which may be viewed as a structured approach to computer programming, an “intermediate” between the levels of a programming paradigm and a concrete algorithm. A contrasting example of pattern 254 comprises architectural patterns, or general, reusable solutions to a commonly occurring problem in software architecture within a given context. Architectural patterns are similar to software design patterns but have a broader scope. Architectural patterns address various issues in software engineering, such as computer hardware performance limitations, high availability, and minimization of business risk. Another example of pattern 254 further comprises interaction design patterns, generally defined as a way to describe solutions to common usability or accessibility problems in a specific context. They document interaction models that make it easier for users to understand an interface and accomplish their tasks.

In additional embodiments, integration module 250 can further comprise coupler 284 operatively coupling integration module 250 via first gateway 230, whereby via coupler 284, integration module 250 has access to microservice 234 and database 238 (i.e., a design user can access microservices 234 and database 238 and use such elements in her composition of an integration by combination with or manipulation of the elements further comprising integration module 250).

As illustrated in FIG. 2, user interface 270 can generally be defined as the industrial design field of human-computer interaction, space where interactions between humans and machines occur. A goal of this interaction is to allow effective operation and control of the machine from the human end, while the machine simultaneously feeds back information that aids the operators' decision-making process. Examples of this broad concept of user interfaces include the interactive aspects of computer operating systems, hand tools, heavy machinery operator controls, and process controls. The design considerations applicable when creating user interfaces are related to or involve such disciplines as ergonomics and psychology. Generally, the goal of user interface design is to produce a user interface which makes it easy (self-explanatory), efficient, and enjoyable (user-friendly) to operate a machine in the way which produces the desired result. This generally means that the operator needs to provide minimal input to achieve the desired output, and also that the machine minimizes undesired outputs to the human.

In a further aspect of the exemplary embodiment, user interface 270 can be operatively coupled to communication services module 230 and integration module 250 via first gateway 240 and second gateway 260. A design user can compose an integration flow at user interface 270 by manipulating pattern 254 through combining it with any one or a combination of the following elements, microservice 232, application programming interface 234, and application component 252.

A design user can commonly be a developer who is specifically focused on building integrations between applications. Design users are often a person within an organization who understands the business, understands her client needs, understands the subject matter related to a business process, understands data or design requirements, is the person who is technically savvy and well versed in using applications related to analytics, reporting tools, and the like. These types of “business users” or “citizen integrators” are viewed in the industry as much spatially closer to available data regardless of what their task is in the organization, in one example, whether it is on-boarding new customers or business analytics. A design user is often a “first responder” in a changing business environment and has the skills to rapidly adapt and come up with solutions to address those challenges.

Composing an integration flow comprises making or forming by combining parts or elements of application components with other elements, for example, microservices 232, API 234, or application components 252. An integration flow generally allows a “sender system,” i.e., a design user accessing a network via a first user device (such as, for example, first user device 392 as illustrated below with reference to FIG. 3) to interact with one or more “receiver systems” (such as, for example, second user device 394 as illustrated below in FIG. 3) having different communication protocols. A design user can generally define the details for the inbound or outbound processing of a message in the sender and receiver channels. These channels may use adapters to support the communication protocols at the sender side and the receiver side.

When a design user composes an integration flow, i.e., created, edited, or deleted changes may not be visible to any other users (i.e., end users) of the resultant data created by the integration flow until such changes are activated in the integration flow. Commonly, integration flows contain the following defining characteristics, a recipient list, a dynamic router, an interface split, and a mapping feature. The recipient list determines the target receivers depending on, in one exemplary embodiment, static routing conditions. A dynamic router is implemented when a design user does not want defined static conditions for receivers at the time of composition, i.e., the dynamic router determines the target receivers at runtime based on the conditions in a mapping program. When a receiver system uses more than one interface to process messages for different activities in a scenario, the interface split may route the incoming message to the correct interface. Lastly, when the message format handled by the sender and receiver systems is different, the mapping transforms the message format, in one exemplary embodiment, in such a way that the message field at the sender corresponds to the message field at the receiver.

Conceptually, integration flows can be constructed by composing endpoints into one or more message flows. A message flow, for purposes of this specification, is customarily considered to be a unit of work that uses well known messaging patterns.

In one exemplary embodiment of an integration flow, the integration flow may comprise an anonymous function, also known as a function literal, a lambda abstraction, or a lambda expression. An anonymous function can generally be defined as a function definition that is not bound to an identifier. Anonymous functions are often arguments being passed to higher-order functions or used for constructing the result of a higher-order function that needs to return a function. In one example, if the function is only used once, or a limited number of times, an anonymous function may be syntactically lighter than using a named function. Anonymous functions are ubiquitous in functional programming languages and other languages with first-class functions, where they fulfill the same role for the function type as literals do for other data types.

Integration module 250 optionally may allow a design user to create visual data flows to aid in the design and composition of integration flows, define specific map settings that take effect at run time, analyze an integration flow during design for logical consistency, check system definitions for logical consistency to ensure they can be executed, build and port an entire system with simple mouse-clicks, build and deploy all of the integration objects and supporting data (such as, for example, lookup files and scripts), defining parameters for different servers representing different operating environments, automate deployment definitions that are specific to each server, specify, within a script, that either all maps are built and transferred or that only a specific subset of the maps in a system are built and transferred, and the like.

For purposes of this specification and the claims, manipulating a pattern through combination with any combination of microservice 232, application programming interface 234, and application component 252 can generally be defined as handling or controlling, via, in exemplary embodiments, integration module 250 through direct control or influence of the design user accessing integration module 250 via user interface 270.

Additional embodiments of user interface 270 further contemplate user interface 270 comprising providing access to application component 252 and pattern 254 to the design user, user interface 270 providing access to microservice 232 and database 238 to the design user, and user interface 270 further allowing the design user to compose the at least one integration flow via a combination of one or more of the following, at least one application component 252, at least one microservice 232, and at least one pattern 254.

As illustrated in FIG. 2, controller 280 can commonly be defined in the industry as, for example, a chip, an expansion card, or a stand-alone device that interfaces with the networked or peripheral device. This link may be between two parts of a computer (for example a memory controller that manages access to memory for the computer) or a controller on an external device that manages the operation of (and connection with) that device. Controller 280 can optionally be defined in the opposite sense to refer to a device by which a user, i.e., design user, controls the operation of the computer, as an “in-game” controller. In desktop computers, the controller may be a plug-in board, a single integrated circuit on the motherboard, or an external device. In mainframes, the controller is usually either a separate device attached to a channel or integrated into the peripheral.

Controller 280 can further comprise an operating system 282, a coupler 284, a multimodal input/out 286, and a receiver/transmitter 288.

Operating system 282 can, via a network connection, direct and control the operation and function of CEP 210. Operating system 282 or the central processing unit (CPU) is the electronic circuitry within CEP 210 that carries out the instructions of any computer programs by performing the basic arithmetic, logical, control and input/output (I/O) operations specified by the instructions. The instructions to be executed are generally kept in some form of memory (not shown). Operating system 282 generally directs and controls by managing or guiding by instruction, etc., regulating feedback on CEP 210, and the like.

Coupler 284 can, via a network connection, operatively couple first gateway 240, second gateway 260, communication services module 230, integration module 250, and user interface 270. Coupler 284 can be any computing device which “couples” various computing elements. In software engineering, “coupling” is generally defined as the degree of interdependence between software modules, for example, a measure of how closely connected two routines or modules are or the strength of the relationships between modules. Coupling is usually contrasted with cohesion. Low coupling often correlates with high cohesion and vice versa. Low coupling is often a sign of a well-structured computer system and a good design, and when combined with high cohesion, supports the general goals of high readability and maintainability.

Examples of coupling types include but are not limited to procedural programming, which refers to a subroutine of any kind, i.e. a set of one or more statements having a name and preferably its own set of variable names, content coupling, which occurs when one module uses the code of another module, common coupling, which occurs when several modules have access to the same set of global data, external coupling, which occurs when two modules share an externally imposed data format, communication protocol, or device interface (e.g., related to communication to external tools and devices), control coupling, or one module controlling the flow of another, by passing it information on what to do, stamp coupling also known as data-structured coupling, which occurs when modules share a composite data structure and use only parts of it (e.g., passing a whole record to a function that needs only one field of it), data coupling, something which occurs when modules share data through, for example, parameters (e.g., each datum is an elementary piece, and these are the only data shared (i.e., passing an integer to a function that computes a square root)), subclass coupling, which describes the relationship between a child and its parent (i.e., the child is connected to its parent, but the parent is not connected to the child), temporal coupling, which occurs when two actions are bundled together into one module just because they happen to occur at the same time, and the like.

Multimodal input/output 286 can, via a network connection, receive a multimodal input and provide a multimodal output based on a design user requirement received through the user interface 270. Multimodal input/out 286 can be any of the devices or pieces of hardware used by a human (or any other system) to communicate with a computing device. In one example, a keyboard or computer mouse is an input device for a computer, while monitors and printers are output devices. Devices for communication between computers, such as modems and network cards, typically perform both input and output operations. The designation of a device as either input or output, or both, depends on perspective. In one general example, mouse and keyboards take physical movements that the human user outputs and convert them into input signals that a computer can understand; the output from these devices is the computer's input. Similarly, printers and monitors take signals that a computer outputs as input, and they convert these signals into a representation that human users can understand. From the human user's perspective, the process of reading or seeing these representations is receiving input; this type of interaction between computers and humans is studied in the field of human-computer interaction.

In computer architecture, the combination of the CPU and main memory, to which the CPU can read or write directly using individual instructions, is considered the brain of a computer. Any transfer of information to or from the CPU/memory combo, for example by reading data from a disk drive, is considered input/output and something which multimodal input/output 286 would be responsible.

In its most basic sense, multimodality is a theory of communication and social semiotics. Multimodality describes communication practices in terms of the textual, aural, linguistic, spatial, and visual resources—or modes—used to compose messages. Where media are concerned, multimodality is the use of several modes (media) to create a single artifact. The collection of these modes, or elements, contributes to how multimodality affects different rhetorical situations or opportunities for increasing an audience's reception of an idea or concept. Everything from the placement of images to the organization of the content creates meaning. This is the result of a shift from the isolated text being relied on as the primary source of communication, to the image being utilized more frequently in the digital age. While multimodality as an area of academic study did not gain traction until the twentieth century, all communication, literacy, and composing practices are and always have been multimodal.

The second group of multimodal systems presents users with multimedia displays and multimodal output, primarily in the form of visual and auditory cues. Interface designers have also started to make use of other modalities, such as touch and olfaction. Proposed benefits of multimodal output system include synergy and redundancy. The information that is presented via several modalities is merged and refers to various aspects of the same process. The use of several modalities for processing the same information provides an increased bandwidth of information transfer. Multimodal output is used mainly for improving the mapping between communication medium and content and to support attention management in a data-rich environment where operators face considerable visual attention demands.

A design user requirement or user requirement(s) specification is a document usually used in software engineering that specifies what a user, i.e., the design user, expects the application to be able to do.

Receiver/transmitter 288 can, via a network connection, receive and transmit a feedback of the integration flow to the design user in response to an occurrence of an event. A transmitter generally is a device used to transmit signal from one place to the other. The signal may often consist of information in the form of voice, video, data, images, or the like. Transmitters often use some form of modulation to transmit a signal over some distance as per design of the system. They optionally use amplifiers to boost the amplitude of the signal to cover the required transmission distance. The typical modulation scheme used in the transmission system is broadly categorized into analog and digital. Analog modulation types include AM, FM, PM, SSB, and the like. Digital modulation types include ASK, FSK, PSK, QPSK, QAM, and the like. After a transmitted signal goes through a certain distance, it may be received at the receiver. A device which decodes the transmitted information from the received signal is known as a receiver. Similar to the power amplification in the transmitter, receiver too often uses amplification of received signal with a focus on low noise amplification.

Receiver/transmitter 288 generally receives and transmits, which are customarily defined as to send out or forward, dispatch, a data signal, and also to admit or take into its possession a data signal for further use or processing.

Feedback, for this specification and the claims, can be further defined as feedback loops, which provide generic mechanisms for controlling the running, maintenance, and evolution of software and computing systems. Feedback-loops are essential models in the engineering of adaptive software, as they define the practice of the interactions among the control elements over the adaptation process, to guarantee system properties at run-time. Optionally, the application of feedback loops can be used to control dynamic properties and the design and evolution of autonomic software systems.

Examples of an event or network occurrence include, but are not limited to, power outages, node failures, communication tower failures or damage, natural disasters impacting nodes or groups of nodes, routine or unscheduled maintenance associated with nodes, terrorist attacks, and virtually any other event or occurrence affecting an integration flow optimization, further including any action, act, or instance, something that happens, i.e., an incident.

Additional embodiments of controller 280 further contemplate operatively coupling via coupler 284 also comprising a multidirectional data exchange between communication services module 230, integration module 250, and user interface 270.

Further contemplated embodiments include multimodal input/output 286 providing the multimodal output further comprising receiving and analyzing an at least one activity detail collected via metadata discoverer 236 and stored in database 238. In one example, an activity detail can be a call detail record (CDR), a data record produced by a telephone exchange or other telecommunications equipment that documents the details of a telephone call or other telecommunications transaction (including, but limited to, voicemail, text message, and the like) that passes through that facility or device. This type of record contains various attributes of the call, such as, for example, time, duration, completion status, source number, and destination number. These type of activity detail further contain metadata, i.e., data about data, optionally with data fields that describe a specific instance of a telecommunication transaction but does not include the content of that transaction.

In another example, an activity detail can be an IP Detail Record (IPDR), which provides information about Internet Protocol (IP)-based service usage and other activities that can be used by support systems as a type of feedback. The content of the IPDR can be set or determined by an Internet service provider (ISP), network/service element vendor, or any other computing device with instructions for specifying the particulars of IP-based services in a given context.

Additional embodiments of controller 280 contemplate controller 280 receiving one or more multimodal inputs and provides one or more multimodal outputs based on the at least one design user requirement received via user interface 270, controller 280 receiving and transmitting one or more feedbacks to the design user based on the use of the at least one integration flow in response to the occurrence of the event, controller 280 receiving and transmitting the one or more feedbacks to the design user based on the use of the at least one integration flow in response to the occurrence of one or more of the events, and the like.

FIG. 3 illustrates another exemplary embodiment, a system 300 including a communications enablement platform (CEP) 310 (as described in more detail above about CEP 210 in FIG. 2). System 300 further comprises a first user device 392, a second user device 394, CEP 310, and networks 390. Networks 390, as a component of this exemplary embodiment, connects first user device 392, second user device 394, and CEP 310. CEP 310, as embodied as a component of this exemplary embodiment, demonstrates the “communications enablement,” as stated above in more detail in the written description associated with FIG. 2.

As contemplated by exemplary system 300 illustrated in FIG. 3, a design user, via first user device 392 has the ability to compose an integration flow at a user interface, accessible and as displayed at first user device 392, by manipulating a pattern through combination with any one or the combination of the following, a microservice, an application programming interface, and an application component. These elements, as stated above, are all described above in reference to FIG. 2. Once the integration flow is created by the design user at the user interface, the design user has the option to activate the integration for and distribute the application elements via networks to second user device 394. At second user device 394, a recipient at user device 394 may interact with the output of the integration flow, thereafter creating and providing feedback, which may optionally be transmitted via networks 390 to the design user at first user device 392.

As generally used herein, networks 390 can be any system of interconnected computing devices, nodes, and assets. In one example, a network, such as networks 390, includes the Internet that is a global system of interconnected computers that use the standard Internet protocol suite to serve users worldwide with an extensive range of information resources and services.

First user device 392 and second user device 394 can be generally defined as any type of communication endpoint, i.e., any type of communication network node. Devices 392, 394 can be any type of interface exposed by a communicating party or by a communication channel. An example of the latter type of communication endpoint is a publish-subscribe topic or a group in group communication systems. As is commonly understood in the field, a communication endpoint or user device is a discoverable communication node whose scope may be varied to narrow or broaden the discovery zone. Endpoints facilitate a standard programmable layer of abstraction whereby heterogeneous software systems and subsystems may communicate with each other and that the means of communication are decoupled from the communicating subsystems. Examples of first user device 392 and second user device 394 include, but are not limited to, communication terminals, handset devices, wireless phones, desktop computers, laptop computing devices, tablets, other handheld computing devices, and the like.

First user device 392 and second user device 394 may further comprise any electrical or electronic equipment that is connected to an IT infrastructure and that enables or is related to electronic communications (e.g., communication sessions). Examples of these types of assets include, but are not limited to, VoIP phones, mobile phones, fax machines, conventional Plain Old Telephony System (POTS) phones, smartphones, cordless phones, conference room speaker phones, computers, Bluetooth enabled phones, laptops, audio/video conferencing equipment, electronic gaming equipment, printers, copiers, tablet computers, or more generally, any kind of network communication device.

FIG. 4 provides for an exemplary method 400 for composing an integration flow using the communications enablement platform (CEP) individually and as part of the exemplary system each as provided above in reference to FIGS. 2 and 3. Such exemplary methods combine the basic inventive concept(s) as embodied in the above exemplary CEP illustrated in FIG. 2 and the exemplary system, including a CEP depicted in FIG. 3.

Method 400 starts at 402, and at 404 a design user using some form of computing device, in one example, first user device 392 as illustrated and described in reference to FIG. 3, can access a user interface operatively coupled to a communication services module and an integration module of a CEP via a network. In one example, a design user may intend to access the CEP for an exemplary purpose of sending a chat message or text message to all employees of a certain business entity. By way of example, and no way in limitation, in this exemplary instance, the purpose of the chat message or text message is to notify all employees of a weather condition affecting the area closing the business entity for the day.

At 406, the design user can compose the integration flow at the user interface by manipulating a pattern through combining it with one, one or more, or any combination of available microservices, application programming interfaces, and application components. Following the exemplary scenario above, in one example of such manipulation, a design user would select the pattern and application components to serve as the framework of the integration flow, i.e., the “building blocks” creating the application which will result in the chat message or text message. Upon combining the applicable pattern(s) and application components, the design user can select the microservices available for chat messaging or text messaging due to the operative coupling of the communication services module and the integration module and their combined availability through the user interface.

At 408, the design user can activate the integration flow. Activating, for purposes of this specification and the claims may be defined as causing to function or act, or in the alternative, to make active. Continuing the above exemplification, once the integration flow is completed by the design user, the design user would optimally click a screen button, which would then cause the CEP to send the chat or text messages to the intended recipients, based on the pattern and application components functionality enabling the “knowing” of the intended recipients, i.e., employees, and how to reach those employees.

At 410, the output of the integration flow is delivered to an end user, i.e., the person who ultimately uses or is intended to ultimately use a product or service, using a second user device. Likewise, delivering, as used in this specification and the claims, is ordinarily defined as to carry out as designed. In computing, an output is customarily a communication between an information processing system, such as a computer, and the outside world, possibly a human or another information processing system. Outputs are the signals or data transmitted to or received by the system. In additional embodiments, it is further contemplated that output is both synchronous (transmitted simultaneously with input) or asynchronous, which is a form of input/output processing that permits other processing to continue before the transmission has finished. The output that would be delivered, for example, from the scene as presented above, would be a chat message or text message containing words describing the weather condition and the closure of the business entity.

Thereafter, at 412, the end user can interact with the output to create the occurrence of the event resulting in the feedback of the integration flow transmitted to the design user. The created feedback can then be transmitted back to the design user with the process restarting at 404. Maintaining the example from above, the message(s) may further contain additional embedded data allowing the end user, here the employee, for exemplary purposes only, to click a link and be taken to an external website, send a return message to the design user/sender or other employees of the business entity, click an acceptance or receipt link, and the like.

If no output is created at 412, the method thereafter ends at 414.

Additional methods, aspects, and elements of the present inventive concept are contemplated to be used in conjunction with, individually or in any combination thereof which will create a reasonably functional CEP, system, and method for composing an integration flow. It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention.

Moreover, particular exemplary features described herein in conjunction with specific embodiments or aspects of the present invention are to be construed as applicable to any embodiment described within, enabled through this written specification and claims, or apparent based on this written specification and claims. Thus, the specification and drawings are to be regarded in a broad, illustrative, and enabling sense, rather than a restrictive one. It should be understood that the above description of the embodiments of the present invention is susceptible to various modifications, changes, and adaptations, and the same are intended to be comprehended within the meaning and range of equivalents of the appended claims.

1. A communications enablement platform, comprising:
a communication services module further comprising a first series of communication nodes further comprising at least one of each of the following: a microservice, an application programming interface, a metadata discoverer, a database, and a first gateway;
an integration module comprising a second series of communication nodes further comprising at least one of each of the following: an application component, a pattern, and a second gateway, wherein the communication services module and the integration module are operatively coupled via the at least one first gateway and the at least one second gateway;
a user interface, wherein the user interface is operatively coupled to the communication services module and the integration module via the at least one first gateway and the at least one second gateway;
whereby a design user composes an at least one integration flow at the user interface by manipulating the at least one pattern through combination with at least one of the following: the at least one microservice, the at least one application programming interface, and the application component; and
a controller, further comprising:
an operating system, wherein, via a network, the operating system directs and controls the operation and function of the communications enablement platform;
a coupler, wherein, via the network, the coupler operatively couples the at least one first gateway and the at least one second gateway, the communication services module, the integration module, and the user interface;
a multimodal input/output, wherein, via the network, the multimodal input/output receives a multimodal input and provides a multimodal output based on an at least one design user requirement received from the user interface; and
a receiver/transmitter, wherein, via the network, the receiver/ transmitter receives and transmits a feedback of the at least one integration flow to the design user in response to an occurrence of an event.

2. The communications enablement platform of claim 1, wherein the communication services module further comprises the at least one microservice and the database being exposed via the at least one gateway.

3. The communications enablement platform of claim 2, wherein the integration module further comprises the coupler coupling the integration module via the communication services module at the at least one gateway, whereby via the connector the integration module accesses the at least one microservice and the database.

4. The communications enablement platform of claim 1, wherein the user interface further comprises providing access to the at least one application component and the at least one pattern to the design user.

5. The communications enablement platform of claim 2, wherein the user interface further comprising providing access to the at least one microservice and the database to the design user.

6. The communications enablement platform of claim 2, wherein the user interface further comprises allowing the design user to compose the at least one integration flow via a combination of one or more of the following: the at least one application component, the at least one microservice, and the at least one pattern.

7. The communications enablement platform of claim 1, wherein operatively coupling via the coupler further comprises a multidirectional data exchange between the communication services module, the integration module, and the user interface.

8. The communications enablement platform of claim 1, wherein providing the multimodal output further comprises receiving and analyzing an at least one activity detail collected via the metadata discoverer and stored in the database.

9. The communications enablement platform of claim 1, wherein the controller receives one or more multimodal inputs and provides one or more multimodal outputs based on the at least one design user requirement received via the user interface.

10. The communications enablement platform of claim 1, wherein the controller receives and transmits one or more feedbacks to the design user based on the use of the at least one integration flow in response to the occurrence of the event.

11. The communications enablement platform of claim 10, wherein the controller receives and transmits the one or more feedbacks to the design user based on the use of the at least one integration flow in response to the occurrence of one or more of the events.

12. A system, comprising:
an at least one first user device;
an at least one second user device;
a communications enablement platform, further comprising:
a communication services module further comprising a first series of communication nodes further comprising at least one of each of the following: a microservice, an application programming interface, a metadata discoverer, a database, and a first gateway;
an integration module comprising a second series of communication nodes further comprising at least one of each of the following: an application component, a pattern, and a second gateway, wherein the communication services module and the integration module are operatively coupled via the at least one first gateway and the at least one second gateway;
a user interface, wherein the user interface is operatively coupled to the communication services module and the integration module via the at least one first gateway and the at least one second gateway;
whereby a design user composes an at least one integration flow at the user interface by manipulating the at least one pattern through combination with at least one of the following: the at least one microservice, the at least one application programming interface, and the application component; and
a controller, further comprising:
an operating system, wherein the operating system directs and controls the operation and function of the communications enablement platform;
a coupler, wherein the coupler operatively couples the at least one first gateway and the at least one second gateway, the communication services module, the integration module, and the user interface;
a multimodal input/output, wherein the multimodal input/output receives a multimodal input and provides a multimodal output based on an at least one design user requirement received from the user interface; and
a receiver/transmitter, wherein the receiver/ transmitter receives and transmits a feedback of the at least one integration flow to the design user in response to an occurrence of an event.
A network, wherein the network connects the at least one first user device, the at least one second user device, and the communications enablement platform via the controller.

13. The system of claim 12, wherein the communication services module further comprises the at least one microservice and the database being exposed via the at least one gateway.

14. The system of claim 12, wherein the integration module further comprises the coupler coupling the integration module via the communication services module at the at least one gateway, whereby via the connector the integration module accesses the at least one microservice and the database.

15. The system of claim 12, wherein the user interface further comprises providing access to the at least one application component and the at least one pattern to the design user.

16. The system of claim 13, wherein the user interface further comprises providing access to the at least one microservice and the database to the design user.

17. The system of claim 13, wherein the user interface further comprises allowing the design user to compose the at least one integration flow via a combination of one or more of the following: the at least one application component, the at least one microservice, and the at least one pattern.

18. The system of claim 12, wherein operatively coupling via the coupler further comprises a multidirectional data exchange between the communication services module, the integration module, and the user interface.

19. The system of claim 12, wherein providing the multimodal output further comprises receiving and analyzing an at least one activity detail collected via the metadata discoverer and stored in the database.

20. The system of claim 12, wherein the controller receives one or more multimodal inputs and provides one or more multimodal outputs based on the at least one design user requirement received via the user interface.

21. The system of claim 12, wherein the controller receives and transmits one or more feedbacks to the design user based on use of the at least one integration flow in response to the occurrence of the event.

22. The system of claim 21, wherein the controller receives and transmits the one or more feedbacks to the design user based on use of the at least one integration flow in response to the occurrence of one or more of the events.

23. A method for designing an integration flow via a communications enablement platform, comprising:
a design user using an at least one first user device to access a user interface operatively coupled to a communication services module and an integration module of the communications enablement platform via a network, wherein the communications enablement platform further comprises:
a controller, further comprising:
an operating system, wherein the operating system directs and controls the operation and function of the communications enablement platform;
a coupler, wherein the coupler operatively couples the user interface, the communication services module, and the integration module;
a multimodal input/output, wherein the multimodal input/output receives a multimodal input and provides a multimodal output based on an at least one design user requirement created by the design user; and
a receiver/transmitter, wherein the receiver/transmitter receives and transmits a feedback of the integration flow to the design user in response to an occurrence of an event;
the communication services module further comprising a first series of communication nodes further comprising at least one of each of the following: a microservice, an application programming interface, a metadata discoverer, a database, and a first gateway;
the integration module further comprising a second series of communication nodes further comprising at least one of each of the following: an application component, a pattern, and a second gateway, wherein the communication services module and the integration module are operatively coupled via the at least one first gateway and the at least one second gateway; and
the user interface being operatively coupled to the communication services module and the integration module via the at least one first gateway and the at least one second gateway;
the design user composing the integration flow at the user interface by manipulating the at least one pattern through combination with at least one of the following: the at least one microservice, the at least one application programming interface, and the application component;
the design user activating the integration flow delivering of an output to an end user using an at least one second user device; and
the end user interacts with the output to create the occurrence of the event resulting in the feedback of the integration flow transmitted to the design user.
